(19) United States
(12) Patent Application Publication
(10) Pub. No.: US 2014/0046633 A1
(43) Pub. Date: Feb. 13, 2014

(54) SIMULATION APPARATUS AND METHOD CAPABLE OF DESIGNING AND SIMULATING MODEL SEPARATELY

(71) Applicant: ELECTRONICS AND TELECOMMUNICATIONS RESEARCH INSTITUTE, (US)

(72) Inventor: In-Geol CHUN, Seoul (KR)

(73) Assignee: ELECTRONICS AND TELECOMMUNICATIONS RESEARCH INSTITUTE, Daejeon (KR)

(21) Appl. No.: 13/779,264

(22) Filed: Feb. 27, 2013

(30) Foreign Application Priority Data
Aug. 10, 2012 (KR) 10-2012-0087868

(51) Int. Cl. G06F 17/50

(52) U.S. Cl. CPC G06F 17/5009
USPC 703/1

(57) ABSTRACT

The present invention relates to a simulation apparatus and a method for designing and simulating a model concurrently but separately. The simulation apparatus includes a model designing device configured to design a plurality of simulation models, and a model simulating device configured to be physically separated from but logically connected to the model designing device to simulate the plurality of simulation models designed in the model designing device.

### CROSS-REFERENCE TO RELATED APPLICATION

This application claims the benefit under 35 U.S.C. §119(a) of Korean Patent Application No. 10-2012-0087868, filed on Aug. 10, 2012, the entire disclosure of which is incorporated herein by reference for all purposes.

### BACKGROUND

1. Field

The following description relates to a simulation technology and, more specifically, to a technology for designing and simulating a model separately.

2. Description of the Related Art

With computing systems utilized widely in society, unexpected and complicated drawbacks have appeared, and model experiments or simulations have been developed to address such drawbacks. A simulation is performed to discover characteristics of a real-world process or system by repeatedly applying a formula representing the process or system. In short, a simulation is a process to check and prevent the possibility that any problem may occur.

In a perfect world, an experiment can be conducted to fix and avoid any problems with safety and security. However, it is impractical to construct a real product every time to see if an unexpected event may happen, and simulations have been created to deal with this problem.

In order to perform a simulation, a program representing a real-like situation needs to be stored and then operated under a given condition. The conditions may be various. In this manner, it is possible to achieve a simulation result almost equivalent to a real experiment result. Since the simulation result can be easily achieved, it is expected that simulation may have a significant impact with considerably less costs within a short time.

In general, a user needs to design and store a simulation model in a computer in order to perform a simulation. In addition, a simulation computer affects the design of a simulation model, so a simulation needs to be performed in the (physically/logically) same area where the simulation computer is located. On top of that, if multiple users wish to design simulation models, they need to do so sequentially, not concurrently.

A simulation model is usually designed based on a simulator, and it is compiled along with the simulator. Recently, simulations are widely used in various ways in more sophisticated industries, and thus more knowledge is required to perform a simulation. Under these circumstances, it is now almost impossible for a group of several people to design their own simulation model in a specific area.

In particular, recent developments in IT convergence technologies has triggered a new trend where experts from diverse fields exchange, share and mix up their knowledge to develop a new system. Accordingly, a demand for computers with mass capacity has significantly grown to simulate a simulation model which is a coherent body of knowledge in diverse fields. Hence, a conventional simulation method is now too inconvenient. In the conventional simulation method, a new simulation model should be designed each time a simulation is performed, and a previously-designed simulation model cannot be reused due to the difference in simulators. Thus, the conventional simulation method requires higher costs for performing a simulation, compared to the present invention.

### SUMMARY

The following description relates to a simulation apparatus capable of designing and simulating a simulation model separately and a method thereof. Specifically, the following description relates to a simulation apparatus capable of concurrently designing a plurality of simulation models and concurrently simulating a plurality of simulation models by distributing the simulation models, and a method thereof.

In one general aspect of the present invention, a simulation apparatus is provided, and the simulation apparatus includes a model designing device configured to design a plurality of simulation models; and a model simulating device configured to be physically separated from but logically connected to the model designing device via a network and comprise a plurality of simulation units, each simulation unit simulating each of the plurality of simulation models.

The model designing device may include a plurality of designing units configured to design the plurality of simulation models and pieces of simulation information respectively corresponding to the plurality of simulation models; a storage unit configured to store the plurality of simulation models and the pieces of simulation information; and a plurality of result analyzing units configured to analyze simulation results generated in each simulation unit. The plurality of designing units and the plurality of result analyzing units may be connected to the storage unit via a network.

Each of the plurality of designing units may includes a model designer configured to design each simulation model; an simulation information designer configured to design each piece of simulation information; a model visualizer configured to visualize each simulation model using each piece of simulation information; a component model generator configured to generate a component model based on the plurality of simulation model and store the component model in the storage unit; and a model simulation information generator configured to generate a piece of model simulation information necessary to simulate the generated component model, and store the piece of model simulation information in the storage unit. The plurality of the model designers may be distributed but able to design the simulation models concurrently, and the plurality of the simulation information designers may be distributed but able to design the pieces of simulation information concurrently.

The component model generator may be able to reuse a previously-used component model stored in the storage unit.

The result-analyzing-model interpreter may interpret a result-analyzing-model selected by a user from among diverse result-analyzing-models stored in the storage unit, and transmit the interpreted result-analyzing-model to the result interpreting engine.

The model simulating device may include the storage unit configured to store the plurality of simulation models and the pieces of simulation information; and the plurality of simulation units configured to simulate the plurality of simulation models using the pieces of simulation information, each simulation model and each piece of simulation information stored in the storage unit. The storage unit and the plurality of simulation units may be connected via a network.

Each of the plurality of simulation units may include a model analysis unit configured to analyze a component model stored in the storage unit; an simulation information interpreter configured to interpret a piece of model simulation information stored in the storage unit; a simulation engine configured to simulate the analyzed component model using the interpreted piece of model simulation information; and a simulation result generator configured to generate a simulation result using information output from the simulation engine.

The model analysis unit may analyze the component models stored in the storage unit, select one of the component models to be simulated in the simulation engine, and transmit the selected component model to the simulation engine, and the simulation information may interpreter interpret the pieces of simulation information, select one of the pieces of simulation information necessary to execute the simulation engine, and transmit the selected piece of simulation information to the simulation engine.

The simulation engine may perform a simulation concurrently with simulation engines of other simulation units. The simulation engine may perform a simulation by applying a plurality of pieces of model simulation information in a component model or by applying a piece of simulation information in a plurality of component models.

In another general aspect of the present invention, a simulation method of a simulation apparatus is provided, and the simulation method includes concurrently designing simulation models and pieces of simulation information necessary to simulate the simulation models in a plurality of designing units; concurrently simulating the simulation models using the pieces of simulation information in a plurality of simulation units; and concurrently analyzing simulation results in a plurality of result analyzing units.

Other features and aspects will be apparent from the following detailed description, the drawings, and the claims.

### BRIEF DESCRIPTION OF THE DRAWINGS

FIG. 1 is a diagram illustrating a configuration of a simulation apparatus capable of designing and simulating a simulation model separately according to an exemplary embodiment of the present invention;

FIG. 2 is a diagram illustrating in detail a configuration of a designing unit shown in FIG. 1;

FIG. 3 is a diagram illustrating in detail a configuration of a simulation unit shown in FIG. 1;

FIG. 4 is a diagram illustrating in detail a configuration of a result analyzing unit shown in FIG. 1;

FIG. 5 is a diagram illustrating in detail a configuration of a storage unit shown in FIG. 1;

FIG. 6 is a flow chart illustrating a process for designing a simulation model in a simulation apparatus capable of designing and simulating a simulation model separately according to an exemplary embodiment of the present invention;

FIG. 7 is a flow chart illustrating a process for simulating a simulation model in a simulation apparatus capable of designing and simulating a simulation model separately according to an exemplary embodiment of the present invention; and

FIG. 8 is a flow chart illustrating a process for analyzing a simulation result in a simulation apparatus capable of designing and simulating a simulation model separately according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

An operating environment where a simulation apparatus and a simulation method according to an exemplary embodiment of the present invention may be implemented may have a plurality of systems. In addition, each system may include functional components required to perform a distinct function. Herein, well-known technologies and elements of the operating environment in which the simulation apparatus and the simulation method may be implemented will not be provided, and those skilled in the art may have no difficulty understanding that the system and the method according to exemplary embodiments of the present invention may be realized in various ways.

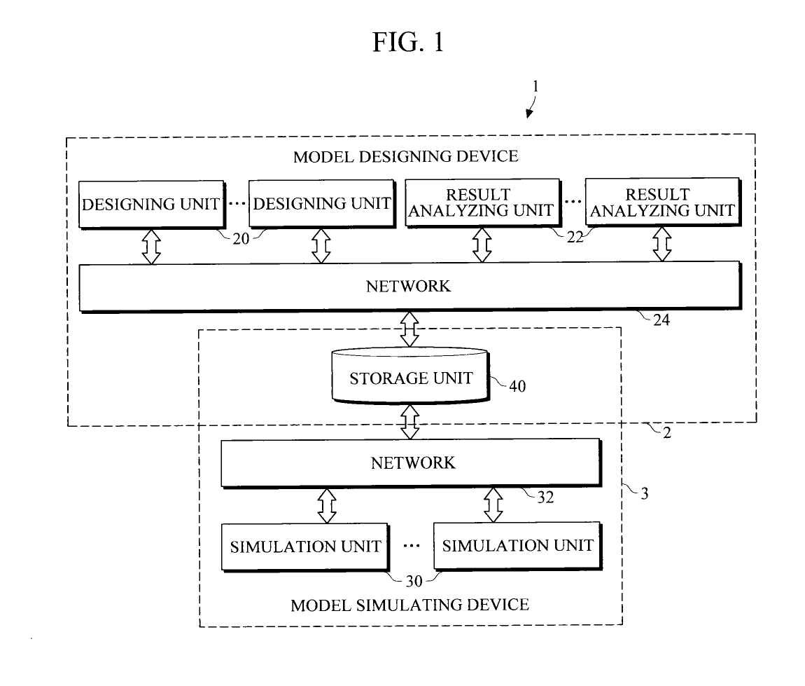

FIG. 1 is a diagram illustrating an example of a simulation apparatus capable of designing and simulating a model separately.

Referring to FIG. 1, the simulation apparatus 1 capable of designing and simulating a model separately (hereinafter, referred to as a simulation apparatus) includes a model designing device 2 and a model simulating device 3. The model designing device 2 configured to design a model may be separable from the model simulating device 3 configured to simulate the designed model. If necessary, the model designing device 2 and the model simulating device 3 may be connected to each other via a network. That is, the model designing device 2 may be physically separate from the model simulating device 3, but logically connected to model simulating device 3 via a network. Since the model designing device 2 and the model simulating device 3 are separate from each other, a model may be designed and simulated separately.

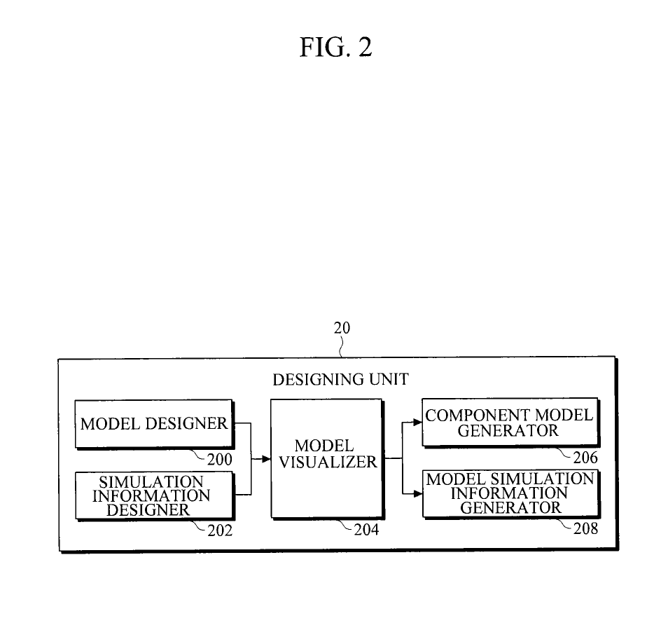

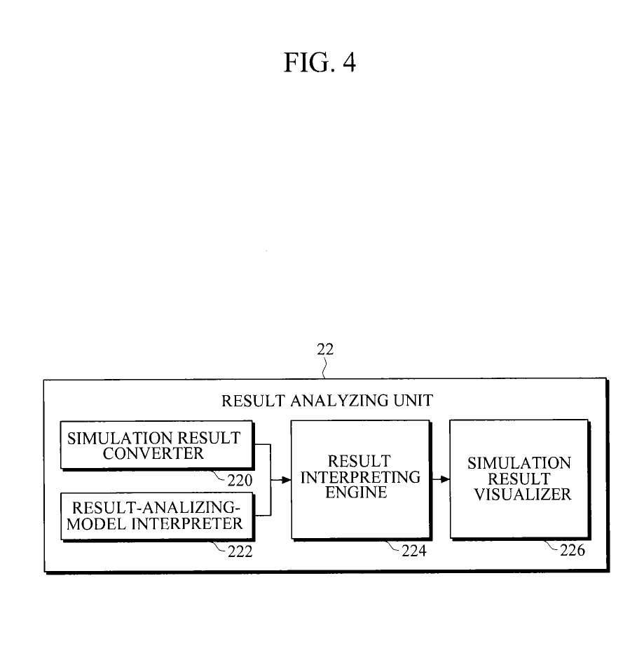

The model designing device 2 may include a designing unit 20, a result analyzing unit 22 and a storage unit 40. The designing unit 20 designs a simulation model and a piece of simulation information. In addition, a plurality of the designing units 20 may be provided as shown in FIG. 1. The storage unit 40 stores and manages the simulation model and the piece of simulation information, each designed in the designing unit 20. The result analyzing unit 22 analyzes a simulation result generated in a simulation unit 30 of the model simulating device 3. In addition, a plurality of the result analyzing units 22 may be provided as shown in FIG. 1. The designing unit 20 and the result analyzing unit 22 may be connected to the storage unit 40 via a network 24. Configuration of the designing unit 20 will be described in detail with reference to FIG. 2, and configuration of the result analyzing unit 22 will be described in detail with reference to FIG. 4.

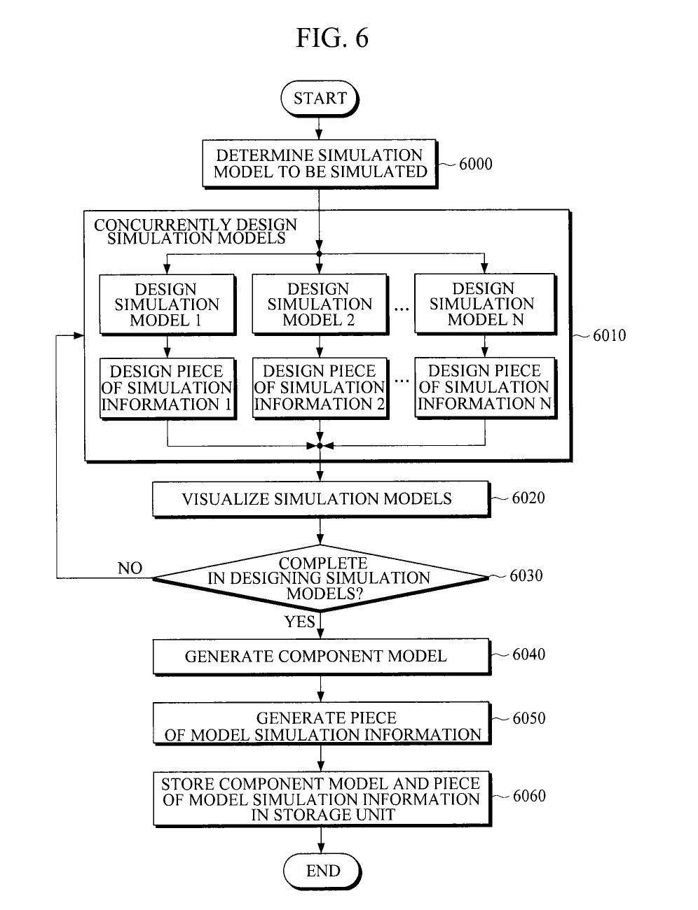

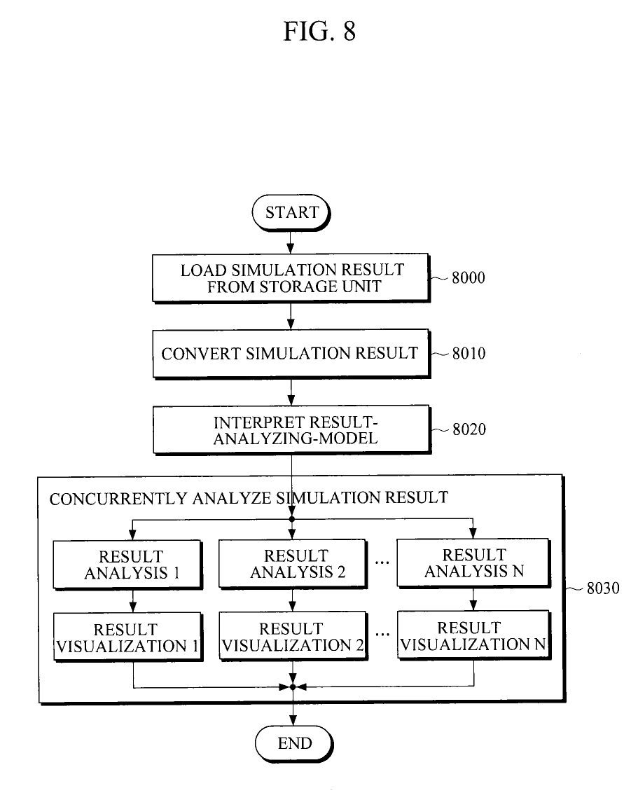

In the case where a plurality of the designing units 20 are provided, a plurality of the designing units 20 may concurrently design simulation models and pieces of simulation information. In addition, in the case where there are a plurality of the result analyzing units 22, a plurality of the result analyzing units 22 may analyze simulation results concurrently. A process for concurrently designing simulation models and pieces of simulation information in a plurality of the designing units 20 will be described with reference to FIG. 6. In addition, a process for concurrently analyzing simulation results in a plurality of the result analyzing units 22 will be described with reference to FIG. 8.

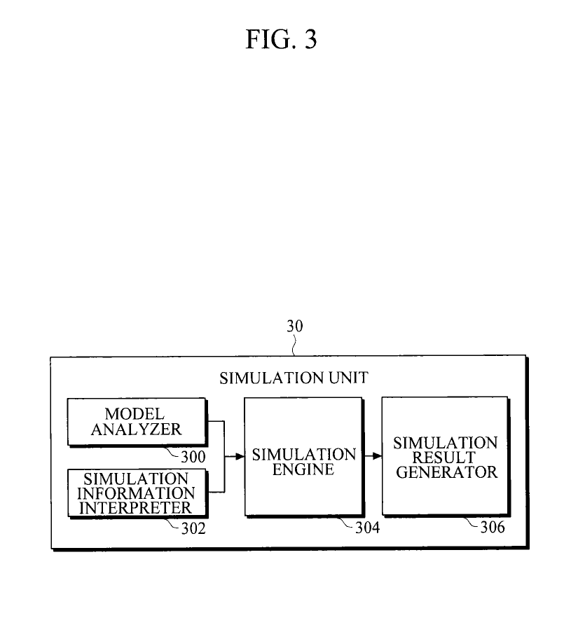

The model simulating device 3 includes the storage unit 40 and the simulation unit 30. The storage unit 40 stores and manages the simulation models and the pieces of simulation information, each designed in the model designing device 2. The simulation unit 30 simulates the simulation models using the pieces of simulation information, each stored in the storage unit 40. At this time, a plurality of the simulation units 30 may be provided. Each of a plurality of the simulation units 30 may be connected to the storage unit 40 via the network 32. Configuration of the simulation unit 30 will be described in detail with reference to FIG. 3.

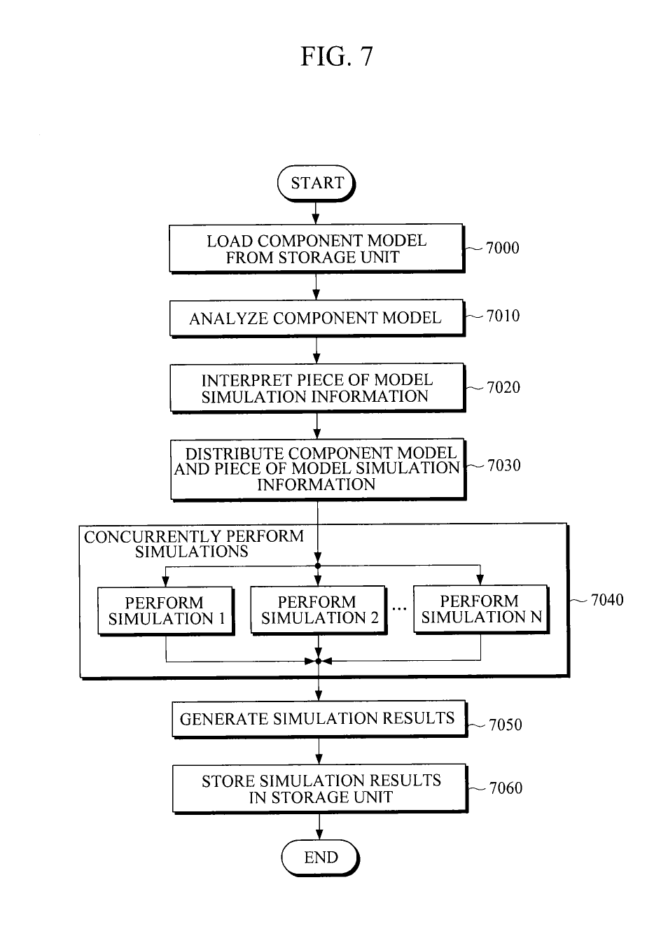

In the case where there are a plurality of the simulation units 30, a plurality of the simulation units 30 may perform simulations concurrently. A process for concurrently performing simulations in a plurality of the simulation units 30 will be described with reference to FIG. 7.

FIG. 2 is a diagram illustrating the designing unit 20 of FIG. 1.

Referring to FIGS. 1 to 2, the designing unit 20 includes a model designer 200, a simulation information designer 202, a model visualizer 204, a component model generator 206 and a model simulation information generator 208.

The model designer 200 designs a simulation model. The simulation information designer 202 designs a piece of simulation information required to simulate the simulation model. The simulation model and the piece of simulation information may be designed in response to a user's manipulation. The model visualizer 204 visualizes the simulation model, designed in the model designer 200, using the piece of simulation information, designed in the simulation information designer 202. The visualization means displaying graphic information to a user. The model visualizer 204 may visualize the simulation model using the piece of simulation information by applying the simulation information in the simulation models. After checking the simulation model visualized by the model visualizer 204 using the piece of simulation information, the user is able to design another simulation model and another piece of simulation information, if necessary.

The component model generator 206 generates a component model based on the simulation models that are designed in the model designer 200, and stores the generated component model in the storage unit 40. The model simulation information generator 208 generates a piece of model simulation information required to simulate the component model generated in the component model generator 206, and stores the generated piece of model simulation information in the storage unit 40.

According to an exemplary embodiment of the present invention, a plurality of model designers are distributed but able to design simulation models concurrently, and a plurality of simulation information designers are distributed but able to design simulation information concurrently.

According to an exemplary embodiment of the present invention, the model designer 200 and the simulation information designer 202 are able to perform respective operations separately. Specifically, the model designer 200 designs a simulation model, while the simulation information designer 202 designs a piece of simulation information. In addition, the model designer 200 may reuse a previous-designed simulation model and the simulation information designer 202 may reuse a previously-designed piece of simulation information. For example, if a user wishes to reuse a simulation model previously designed by the model designer 200, the component model generator 206 may reuse a component model previously stored in the storage unit 40 and the model simulation information generator 208 may generate a new piece of model simulation information. In another example, if a user wishes to reuse a piece of model simulation information previously designed by the model simulation information generator 202, the model simulation information generator 208 may reuse a model simulation information previously stored in the storage unit 40 and the component model generator 206 may generate a new component model.

FIG. 3 is a diagram illustrating the simulation unit 30 of FIG. 1.

Referring to FIGS. 1 and 3, the simulation unit 30 includes a model analyzer 300, a simulation information interpreter 302, a simulation engine 304 and a simulation result generator 306.

The model analyzer 300 analyzes a component model stored in the storage unit 40. The simulation information interpreter 302 interprets a piece of model simulation information stored in the storage unit 40. The simulation engine 304 simulates the component model analyzed by the model analyzer 300 using the piece of model simulation information interpreted by the simulation information interpreter 302. The simulation result generator 306 generates a simulation result based on information output from the simulation engine 304.

According to an exemplary embodiment of the present invention, the model analyzer 300 analyzes the component models stored in the storage unit 40, selects one of the component models to be simulated in the simulation engine 304, and transmits the selected component model to the simulation engine 304. In addition, the simulation information interpreter 302 interprets the pieces of model simulation information stored in the storage unit 40, selects one of the pieces of model simulation information necessary to execute the simulation engine 304, and transmits the selected piece of model simulation information to the simulation engine 304.

According to an exemplary embodiment of the present invention, in the case where there are a plurality of the simulation engines 304, a plurality of the simulation engines 304 may perform simulations concurrently. That is, component models analyzed by the model analyzer 300, and pieces of corresponding model simulation information interpreted by the simulation information interpreter 302 are distributed to a plurality of the simulation engines 304, and each of a plurality of the simulation engines 304 may simulate a distributed component model using a distributed piece of model simulation information.

According to an exemplary embodiment of the present invention, the simulation engine 304 loads a component model and a corresponding piece of model simulation information separately from the storage unit 40 in order to reduce simulation costs. At this time, the simulation engine 304 may perform a simulation by applying a plurality of pieces of model simulation information in a component model or by applying a piece of model simulation information in a plurality of component models.

FIG. 4 is a configuration of the result analyzing unit 22 shown in FIG. 1.

Referring to FIGS. 1 and 4, the result analyzing unit 22 includes a simulation result converter 220, a result-analyzing-model interpreter 222, a result interpreting engine 224 and a simulation result visualizer 226.

The simulation result converter 220 converts a simulation result output from the simulation unit 30 into a format that is available in the result interpreting engine 224. The result-analyzing-model interpreter 222 interprets a result-analyzing-model. The result-analyzing-model may be stored in the storage unit 40. Using the result-analyzing-model interpreted by the result-analyzing-model interpreter 222, the result interpreting engine 224 interprets a simulation result converted in the simulation result converter 220. The simulation result visualizer 226 visualizes the simulation result interpreted in the result interpreting engine 224.

The result-analyzing-model interpreter 222 selects a result-analyzing-model that the user wishes to select among diverse result-analyzing-models stored in the storage unit 40, and transmits the selected result-analyzing-model to the result interpreting engine 224. In addition, when multiple users use a plurality of the simulation units 30, each user is able to select a desired result-analyzing-model. In this case, each of the result interpreting engines 224 interprets a simulation result using a result-analyzing-model selected by each user. In addition, each simulation result visualizer 226 provides the user with the simulation result interpreted in each result interpreting engine 224 as visual information.

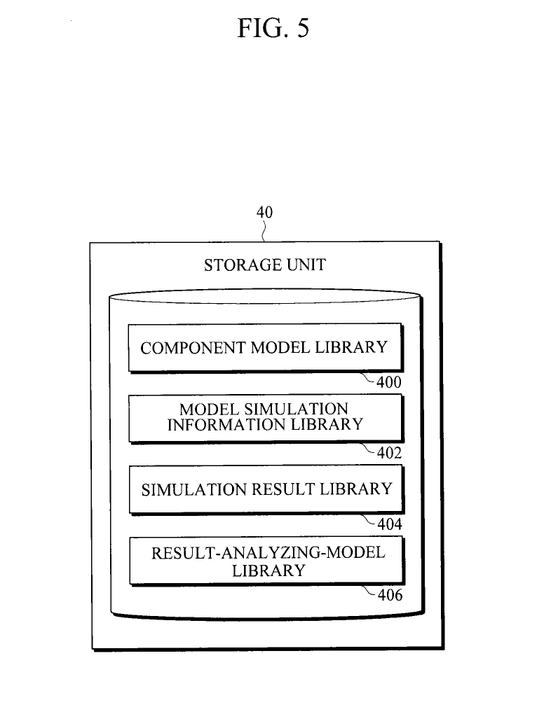

FIG. 5 is a diagram illustrating the storage unit 40 of FIG. 1.

Referring to FIGS. 1 and 5, the storage unit 40 stores simulation models, pieces of simulation information, and result-analyzing-models. According to an exemplary embodiment of the present invention, the storage unit 40 includes a component model library 400 configured to store component models designed in the designing unit 20, a model simulation information library 402 configured to store pieces of model simulation information, a simulation result library 404 configured to store simulation results output from the simulation unit 30, and a result-analyzing-model library 406 configured to store result-analyzing-models one of which a user is able to select.

Meanwhile, a simulation method of the simulation apparatus 1 described with reference with FIGS. 1 to 5 will be described in detail with reference to FIGS. 6 to 8. That is, a process for designing a simulation model (the first step) in the simulation apparatus 1 will be described with reference to FIG. 6; a process for simulating a simulation model (the second step) in the simulation apparatus 1 will be described with reference to FIG. 7; and a process for analyzing a simulation result (the third step) in the simulation apparatus 1 will be described with reference to FIG. 8.

FIG. 6 is a flow chart illustrating a process for designing a simulation model in the simulation apparatus 1 according to an exemplary embodiment of the present invention.

Referring to FIGS. 2 and 6, the designing unit 20 of the simulation apparatus 1 determines a simulation model in 6000, and then designs a simulation model and a piece of simulation information corresponding to the simulation model in response to a user's manipulation. At this time, multiple simulation models and multiple pieces of simulation information may be designed in response to manipulation of multiple users in 6010. Each user designs a simulation model that the user wishes and a piece of simulation information corresponding to the simulation model. If the simulation model and the corresponding piece of simulation information are completely designed, the designing unit 20 visualizes the simulation models by applying the corresponding simulation information in the simulation models in 6020. At this time, after checking the simulation models visualized using the corresponding piece of simulation information, a user is able to design another simulation model and another piece of simulation information corresponding to the newly designed simulation model, if necessary in 6030. If a process for designing the simulation models is completed, the designing unit 20 generates a component model in 6040, and generates a piece of model simulation information corresponding to the generated component model in 6050. If both the component model and the corresponding piece of model simulation information are generated, the designing unit 20 stores the component model and the piece of model simulation information in the storage unit 40 in 6060.

FIG. 7 is a flow chart illustrating a process for simulating a simulation model in the simulation apparatus 1 according to an exemplary embodiment of the present invention.

Referring to FIGS. 3 and 7, the simulation apparatus 1 loads component models stored in the storage unit in 7000, analyzes the loaded component models in 7010, and selecting a component model suitable for the simulation engine 304 from among the loaded component models using the analysis result. In addition, the simulation unit 30 interprets pieces of model simulation information stored in the storage unit, selects one of the pieces of model simulation information necessary to execute the simulation engine 304 in 7020. Next, the selected component model and the selected piece of model simulation information (or component models and pieces of model simulation information, selected as described above, ??) are distributed to a plurality of simulation engines 7030, and a plurality of simulation engines perform simulations concurrently in 7040. After a plurality of simulation engines performs simulations concurrently, the simulation unit 30 generates a simulation result by merging information output from each of a plurality of simulation engine in 7050, and stores the generated simulation result in the storage unit 40 in 7060.

FIG. 8 is a flow chart illustrating a process for analyzing a simulation result in the simulation apparatus 1 according to an exemplary embodiment of the present invention.

Referring to FIGS. 4 and 8, the result analyzing unit 22 of the simulation apparatus loads from the storage unit 40 a simulation result generated in a simulation process in 8000, converts the loaded simulation result into a format available in the result interpreting engine 224 in 8010, loads a user's desired result-analyzing-model from the storage unit 40 and interprets the desired result-analyzing-model in 8020. Next, the simulation result is concurrently analyzed using the interpreted result-analyzing-model (in a plurality of result analyzing units [symbol] ??) in 8030. At this time, the result-analyzing-model selected by a user is used. The simulation result visualizer 226 visualizes the analysis results.

According to an exemplary embodiment of the present invention, it is able to design and simulate a simulation model separately in different devices in different areas.

Furthermore, in the case of simulating a large-scale complex system, such as an IT convergence system, a more convenient method for designing and simulating a simulation model is used. Thus, a user is able to achieve a highly reliable simulation result through significantly sophisticated simulations.

On top of that, the user is also able to reduce costs for designing a simulation by distributing simulation models in a plurality of inexpensive computers, while a high-performance super computer alone performs a simulation in a general sense.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A simulation apparatus comprising:
a model designing device configured to design a plurality of simulation models; and
a model simulating device configured to be physically separated from but logically connected to the model designing device via a network and comprise a plurality of simulation units, each simulation unit simulating each of the plurality of simulation models.

2. The simulation apparatus of claim 1, wherein the model designing device comprises
a plurality of designing units configured to design the plurality of simulation models and pieces of simulation information respectively corresponding to the plurality of simulation models;
a storage unit configured to store the plurality of simulation models and the pieces of simulation information; and
is a plurality of result analyzing units configured to analyze simulation results generated in each simulation unit.

3. The simulation apparatus of claim 2, wherein the plurality of designing units and the plurality of result analyzing units are connected to the storage unit via a network.

4. The simulation apparatus of claim 2, wherein each of the plurality of designing units comprises
a model designer configured to design each simulation model;
an simulation information designer configured to design each piece of simulation information;
a model visualizer configured to visualize each simulation model using each piece of simulation information;
a component model generator configured to generate a component model based on the plurality of simulation model and store the component model in the storage unit; and
a model simulation information generator configured to generate a piece of model simulation information necessary to simulate the generated component model, and store the piece of model simulation information in the storage unit.

5. The simulation apparatus of claim 4, wherein the plurality of the model designers are distributed but able to design the simulation models concurrently, and the plurality of the simulation information designers are distributed but able to design the pieces of simulation information concurrently.

6. The simulation apparatus of claim 4, wherein the component model generator is able to reuse a previously-used component model stored in the storage unit.

7. The simulation apparatus of claim 4, wherein the model simulation information generator is able to reuse a previously-used piece of model simulation information stored in the storage unit.

8. The simulation apparatus of claim 2, wherein the result analyzing unit comprises
a simulation result converter configured to convert each of the simulation results generated in each of the plurality of simulations unit into a format that is available in a result interpreting engine;
a result-analyzing-model interpreter configured to interpret a result-analyzing-model;
the result interpreting engine configured to interpret the converted simulation result using the interpreted result-analyzing-model; and
a simulation result visualizer configured to visualize the interpreted simulation result.

9. The simulation apparatus of claim 8, wherein the result-analyzing-model interpreter interprets a result-analyzing-model selected by a user from among diverse result-analyzing-models stored in the storage unit, and transmits the interpreted result-analyzing-model to the result interpreting engine.

10. The simulation apparatus of claim 1, wherein the model simulating device comprises
the storage unit configured to store the plurality of simulation models and the pieces of simulation information; and
the plurality of simulation units configured to simulate the plurality of simulation models using the pieces of simulation information, each simulation model and each piece of simulation information stored in the storage unit.

11. The simulation apparatus of claim 10, wherein the storage unit and the plurality of simulation units are connected via a network.

12. The simulation apparatus of claim 10, wherein each of the plurality of simulation units comprises
a model analysis unit configured to analyze a component model stored in the storage unit;
an simulation information interpreter configured to interpret a piece of model simulation information stored in the storage unit;
a simulation engine configured to simulate the analyzed component model using the interpreted piece of model simulation information; and
a simulation result generator configured to generate a simulation result using information output from the simulation engine.

13. The simulation apparatus of claim 12, wherein the model analysis unit analyzes the component models stored in the storage unit, selects one of the component models to be simulated in the simulation engine, and transmits the selected component model to the simulation engine, and the simulation information interpreter interprets the pieces of simulation information, selects one of the pieces of simulation information necessary to execute the simulation engine, and transmits the selected piece of simulation information to the simulation engine.

14. The simulation apparatus of claim 12, wherein the simulation engine performs a simulation concurrently with simulation engines of other simulation units.

15. The simulation apparatus of claim 12, wherein the simulation engine performs a simulation by applying a plurality of pieces of model simulation information in a component model or by applying a piece of simulation information in a plurality of component models.

16. A simulation method of a simulation apparatus, the simulation method comprising:
concurrently designing simulation models and pieces of simulation information necessary to simulate the simulation models in a plurality of designing units;
concurrently simulating the simulation models using the pieces of simulation information in a plurality of simulation units; and
concurrently analyzing simulation results in a plurality of result analyzing units.

17. The simulation method of claim 16, wherein the designing of the simulation models and the pieces of simulation information comprises
designing the simulation models and the pieces of simulation information necessary for simulating the simulation model;
visualizing the simulation models using the pieces of simulation information, and, if necessary, designing another simulation model and another piece of simulation information; and
generating a component model based on the simulation models, storing the generated component models, generating a piece of model simulation information necessary for simulating the generated component model, and storing the generated piece of model simulation information.

18. The simulation method of claim 16, wherein the analyzing of the simulation results comprises
converting simulation results output from the plurality of simulation units into a format that is available in the result interpreting engine;
interpreting a result-analyzing-model;
interpreting the simulation results in the result interpreting engine using the interpreted result-analyzing-model; and
visualizing the interpreted simulation results to a user.

19. The simulation apparatus of claim 16, wherein the simulating of the simulation models comprises
analyzing a component model and interpreting a piece of model simulation information;
simulating the analyzed component model using the interpreted piece of model simulation information; and
displaying a simulation result.
